(19) United States
(12) Patent Application Publication
(10) Pub. No.: US 2007/0260665 A1
(43) Pub. Date: Nov. 8, 2007

(54) Method of Specifying and Tracking Precision in Floating-point Calculation

(76) Inventor: Chengpu Wang, Melville, NY (US)

Correspondence Address: WANG, CHENGPU, 40 GROSSMAN STREET, MELVILLE, NY, 11747, US

(21) Appl. No.: 11/379,420

(22) Filed: Apr. 20, 2006

(51) Int. Cl. G06F 7/38

(52) U.S. Cl. 708/498

(57) ABSTRACT

A new floating-point representation and arithmetic called precise representation and arithmetic enables efficient precision storage and tracking during arithmetic operations by (1) discarding the normalization process of conventional arithmetic; (2) reinterpreting the floating-point representation of a signed significand on an exponent as a value based on a precision; (3) providing new rules that facilitate precision tracking during arithmetic operations; and (4) providing means for validating the range defined by the value and the precision of each precise value.

### FIELD OF THE INVENTION

The present invention relates to representing precise values and performing arithmetic operations on operands comprising precise within a computer system. More specifically, the present invention relates to a method and an apparatus for representing arithmetic precisions within a computer system to facilitate efficient arithmetic operations on the precise values.

### DESCRIPTION OF FIGURES

FIG. 1 shows interval representation and arithmetic, which is a prior art of this invention. FIG. 1 is adopted from U.S. Pat. No. 6,658,443, which contains detailed description for FIG. 1.

FIG. 2 shows precise representation, which is the primary figure of this patent application. In this representation, a precise value is a floating-point value 101 comprising a sign 102, a significand 103, and an exponent 104. The precise value is interpreted as a value 105 of “sign significand×2^{exponent}” and a precision 106 of “2^{exponent}”.

FIG. 3 shows a simplified C++ interface of CPrecise class, which is an embodiment of the precise representation and arithmetic. All implementation-oriented codes are removed. The CPrecise class uses the same bit partition as IEEE 754-1985 64-bit conventional floating-point format. The reduction and round-off arithmetic operations are considered implementation details for the CPrecise class. So CPrecise class can be compared directly with the 64-bit conventional floating-point type.

FIG. 4 shows a standard making scheme for the CPrecise class. A source code 201 containing CPrecise class is compiled and linked 205 into a targeted program 202. The target program 202 is specific for each platform comprising an execution unit 207 and a storage and I/O unit 208. The target program 202 is executed 206 on the platform, to process input data 203 and to generate output data 204. In PC, the execution unit 207 comprises CPU and other processors, while the storage and I/O unit 208 is conventionally separated as a storage unit comprising memory, hard disk and CD-RAM, and an I/O unit comprising monitor, mouse, keyboard, and communication ports. However, the network functionality is better described by the storage and I/O unit 208.

FIG. 5 shows some examples of empirical significand error distribution using “C10” precise arithmetic. The left chart shows the empirical significand error distribution of the imaginary results of “FFT” calculation of different order, while the right chart shows the empirical significand error distribution of the real results of “Rev” calculation of different order. In both charts, the x-axis shows the significand error, the y-axis shows the normalized population of the empirical distribution (which is equivalent to the probability density in a theoretical probability distribution), while the inlet label shows the symbol, the input index frequency, the input precision, the calculation order, and the precise value that contains the maximal significand error for each curve.

FIG. 6 shows some examples of empirical significand error distribution using “C11” precise arithmetic. The left chart shows the empirical significand error distribution of the imaginary results of “FFT” calculation of different order, while the right chart shows the empirical significand error distribution of the real results of “Rev” calculation of different order. In both charts, the x-axis shows the significand error, the y-axis shows the normalized population of the empirical distribution (which is equivalent to the probability density in a theoretical probability distribution), while the inlet label shows the symbol, the input index frequency, the input precision, the calculation order, and the precise value that contains the maximal significand error for each curve.

FIG. 7 shows some examples of empirical significand error distribution using “C11” precise arithmetic. The left chart shows the empirical significand error distribution of the imaginary results of “FFT” calculation of different order, while the right chart shows the empirical significand error distribution of the real results of “Rev” calculation of different order. In both charts, the x-axis shows the significand error, the y-axis shows the normalized population of the empirical distribution (which is equivalent to the probability density in a theoretical probability distribution), while the inlet label shows the symbol, the input index frequency, the input precision, the calculation order, and the precise value that contains the maximal significand error for each curve.

FIG. 8 left chart shows the error ratio vs. calculation order. Its x-axis shows the calculation order, its y-axis shows the error ratio, while its inlet label shows the policy for precise arithmetic, the algorithm name, the input signal name, and the real or imaginary part of the result for each curve. It shows that with the increase of calculation order, the error ratio quickly reaches a stable value for each algorithm. FIG. 8 right chart shows the error ratio vs. input index frequency. Its x-axis shows the calculation order, its y-axis shows the error ratio, while its curves adopt the symbols of FIG. 8 left chart. It shows the variation of error ratio regarding to the variations in the input data.

FIG. 9 left chart shows the average uncertainty vs. calculation order. Its x-axis shows the calculation order, its y-axis shows the average uncertainty, while its inlet label shows the policy for precise arithmetic as well as “Intv” for interval arithmetic and “Dbl” for conventional floating-point arithmetic, the algorithm name, the input signal name, and the real or imaginary part of the result for each curve. It shows how the average uncertainty increases for each algorithm with the increase of calculation order. FIG. 9 right chart shows the average uncertainty vs. input index frequency. Its x-axis shows the calculation order, its y-axis shows the error ratio, while its curves adopt the symbols of FIG. 9 left chart. It shows the variation of average uncertainty regarding to the variations in the input data.

FIG. 10 shows empirical significand error distribution for “Rev” calculation using “C10” precise arithmetic. The left chart and right chart show the empirical significand error distribution of the real and imaginary results of different order. In both charts, the x-axis shows the significand error, the y-axis shows the normalized population of the empirical distribution (which is equivalent to the probability density in a theoretical probability distribution), while the inlet label shows the symbol, the input index frequency, the input precision, the calculation order, and the precise value that contains the maximal significand error for each curve.

FIG. 11 shows empirical significand error distribution for “Rev” calculation using “C01” precise arithmetic. The left chart and right chart show the empirical significand error distribution of the real and imaginary results of different order. In both charts, the x-axis shows the significand error, the y-axis shows the normalized population of the empirical distribution (which is equivalent to the probability density in a theoretical probability distribution), while the inlet label shows the symbol, the input index frequency, the input precision, the calculation order, and the precise value that contains the maximal significand error for each curve.

FIG. 12 shows empirical significand error distribution for “Rev” calculation using “C01” precise arithmetic on cosine input signals. The left chart and right chart show the empirical significand error distribution of the real and imaginary results of different order. In both charts, the x-axis shows the significand error, the y-axis shows the normalized population of the empirical distribution (which is equivalent to the probability density in a theoretical probability distribution), while the inlet label shows the symbol, the input index frequency, the input precision, the calculation order, and the precise value that contains the maximal significand error for each curve.

FIG. 13 left chart shows the error ratio vs. input precision for sine input signal of a fixed frequency for 15 order calculations. Its x-axis shows the input precision, its y-axis shows the error ratio, while its inlet label shows the policy for precise arithmetic, the algorithm name, the input signal name, and the real or imaginary part of the result for each curve. It shows that the error ratio for each algorithm is independent of the input precision. FIG. 13 right chart shows the degradation ratio vs. input precision for sine input signal of a fixed frequency for 15 order calculations. Its x-axis shows the input precision, its y-axis shows the degradation ratio, while its inlet label shows the policy for precise arithmetic, the algorithm name, the input signal name, and the real or imaginary part of the result for each curve. It shows that the degradation ratio for each algorithm is independent of the input precision, except when the input precision is extremely small for the “Inv” calculation.

FIG. 14 left chart shows the error ratios of different repeat of “rev” calculation. Its x-axis shows the input precision, its y-axis shows the error ratio, while its inlet label shows the policy for precise arithmetic, the algorithm name, the input signal name, and the real or imaginary part of the result for each curve. FIG. 14 right chart shows the degradation ratios of different repeat of “rev” calculation. Its x-axis shows the input precision, its y-axis shows the degradation ratio, while its inlet label shows the policy for precise arithmetic, the algorithm name, the input signal name, and the real or imaginary part of the result for each curve. The combination of the two charts shows that the degradation ratio can be used to validate the error ratio when they both deviate from their respective normal values for the algorithm implementation.

### BACKGROUND OF THE INVENTION

The computer-implemented conventional floating-point representations and arithmetic is incorporated here as the first reference. The conventional floating-point representations partition a floating-point number into three parts: (1) sign, (2) significand, and (3) exponent, and the value of the number is “sign significand×2^{exponent}”. For example, a 64-bit floating-point number in the ANSI/IEEE Standard 754-1985 has (1) one sign bit, (2) 54 significand bits, and (3) 10 exponent bits. The conventional floating-point representations have a problem of polymorph representation, because “sign (significand×2ⁿ)×2^{exponent-n}” and “sign significand×2^{exponent}” represent equal values for any integer “n”. To address this problem, the conventional floating-point arithmetic always picks the representation of highest possible accuracy or lowest possible precision: If after some operation the most significant bit of a non-zero significand is zero, the significand is left shifted while the exponential is decremented until the most significant bit of the significand becomes 1. This normalization process is a fundamental operation of all conventional floating-point representations and arithmetic, including ANSI/IEEE Standard 754-1985.

The conventional floating-point representations and arithmetic have one fundamental weakness due to its normalization: It has no error tracking strategy. This fundamental weakness leads to several fundamental problems in using the conventional floating point representations and arithmetic.

First, while the conventional floating-point representations always assuming highest possible accuracy or lowest possible precision, except simplest count, real-world measured values all have limited accuracy or precision. For example, while the accuracy of 64-bit representation defined in ANSI/IEEE Standard 754-1985 is always 10⁻¹⁷, the accuracies of measured values range from order-of-magnitude estimation of astronomical measurements, to 10⁻²˜10⁻⁴ of common measurements, to 10⁻¹⁰ of state-of-art measurements of basic physics constants. When a value of commonly 10⁻³ accuracy is stored in the 64-bit floating-point format, only the most significant 10 bits contain true information, while the rest 43 bits contains garbage information generated in the normalization process, and the storing and processing of these excessive garbage bits in the conventional floating-point arithmetic is a huge waste both in time and in resource. More seriously, the accuracy of the original value is forever lost in the normalization process. Then, during subsequential calculations, these garbage information mixes in or even takes over the true information during repeated round off and normalization process, as described in the following.

Second, it is well known that the conventional floating-point arithmetic can amplify error greatly. For example, when calculating (64919121×205117922−159018721×83739041) using the 64-bit floating-point representation and arithmetic defined in ANSI/IEEE Standard 754-1985, both products exceed the 54-bit accuracy of the floating point representation, so they are rounded off during the calculations, as 13316075197586562 and 13316075197586560 respectively, and the result becomes 2 instead of the correct answer 1. Then, in the normalization process, this 2 will become 2.0000000000000000, which gives a wrong accuracy or precision of the value as large as 1017 fold than the true accuracy. Such amplification of round-off errors happens constantly in using floating point representations and arithmetic, because round-off happens for almost every addition and multiplication, while normalization happens for almost every subtraction and division. In fact, self-discipline is the sole method in trying to avoid gross error amplification by round-off and normalization, such as avoiding subtraction of large products. When nowadays calculations become more and more complicated, especially when they are regressive, dispersive, or evolutionary over long period of time, the effect of error amplification during calculation using the conventional floating-point representations and arithmetic is untraceable, and the correctness of the results—let along their precisions—is very difficult or even impossible to be known by the calculation itself.

So this invention describes a new system of computer-implemented floating-point representation and arithmetic which corrects the above fundamental weakness and fundamental problems of the conventional floating-point representations and arithmetic. In this new representation, each floating-point value contains a value-precision pair, which is traced automatically in the new arithmetic.

### Description of the Related Art

There are three traditional techniques of specifying a value-precision pair: (1) by statistics, (2) by interval representation & arithmetic, and (3) by affine representation & arithmetic. All these techniques are incorporated in this patent application as both references and prior arts.

The following is a reference list on statistics:
1 Sylvain Ehrenfeld and Sebastian B. Littauer, Introduction to Statistical Methods (McGraw-Hill, 1965);
2 John R. Taylor, Introduction to Error Analysis: The Study of Output Precisions in Physical Measurements (University Science Books, 1997);
3 Michael Evans and Jeffrey S. Rosenthal, Probability and Statistics: The Science of Uncertainty (W. H. Freeman, 2003).

Statistics views a value-precision pair as a mean-deviation pair. In fact, many experimental value-precision pairs are obtained as the empirical mean-deviation pair by statistical inference from multiple measurements of a value. However, the precision is an indicator of reliable order-of-magnitude of the value, and it is different from the deviation. For example, a single reading of a 16-bit ideal analog-to-digital converter has well defined precision, but this precision can not be viewed as a deviation. Also, unlike the deviation in a mean-deviation pair, the precision of a value-precision pair is not expected to participate in statistical hypothesis-testing, so its accuracy can be as low as 1 bit, so that storing a precision as a conventional floating point value is not efficient at all. Treating a value-precision pair as a mean-deviation pair generally faces insurmountable challenges in obtaining result precision from arithmetic operations. For an example, the deviation of subtracting X from Y depends strongly how X and Y are statistically correlated, which is usually not known. Even if both X and Y are obtained as mean-deviation pairs, and both their individual underline distributions are precisely known, the test of their correlation is still very complicated and hypothesis-dependent.

Let X-δX be a value-precision pair on X. It is very useful to borrow some statistical technical in handling the X-δX pair by treating it also as a mean-deviation pair. When X and Y are not correlated at all:
δ(X+Y)=√((δX)²+(δY)²) (1)
When X and Y are fully correlated:
δ(X+Y)=δX+δY (2)
δ(X−Y)=|δX−δY| (3)
Generally:
(1)<=δ(X+Y)<=(2) (4)
(1)>=δ(X−Y)>=(3) (5)

The following is a reference list on interval arithmetic:
1 R. E. Moore, Interval Analysis (Prentice Hall, 1966).
2 W. Kramer, A prior worst case error bounds for floating-point computations, IEEE Trans. Computers, vol. 47, pp 750-756, July 1998
3 Some experiments on the evaluation of functional ranges using a random interval arithmetic, Mathematics and Computers in Simulation, 2001, Vol. 56, pp. 17-34.
4 U.S. Pat. No. 6,658,443, Method and apparatus for representing arithmetic intervals within a computer system
5 U.S. Pat. No. 6,751,638, Min and max operations for multiplication and/or division under the simple interval system
6 U.S. Pat. No. 6,842,764, Minimum and maximum operations to facilitate interval multiplication and/or interval division

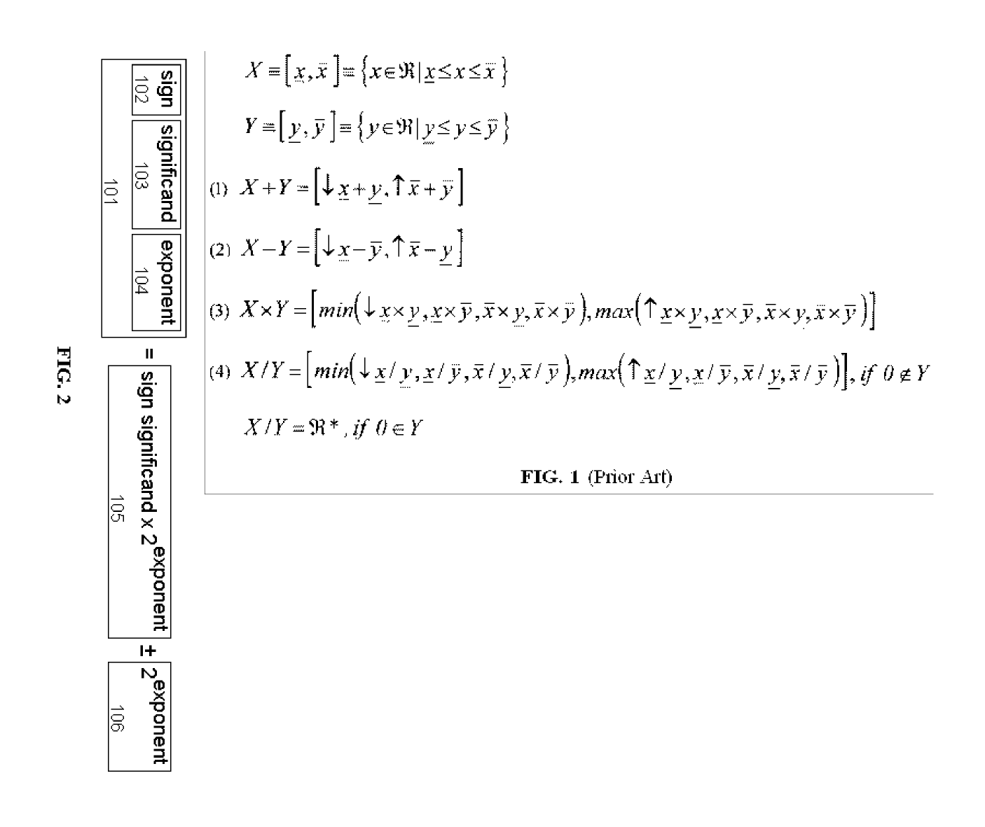

The interval floating-point representations assumes that the true value of X is always in the range defined by [X−δX, X+δX]. FIG. 1 shows the interval floating-point representation and arithmetic. According to FIG. 1:
δ(X+Y)=δX+δY (6)
δ(X−Y)=δX+δY (7)

So equation (6) is an over-estimation of equation (4), and equation (7) is a vast over-estimation of equation (5). Generally, it is well known that the interval arithmetic over-estimates error greatly. Attempts has been made to narrow the interval randomly during some calculation, however, such heuristic technique is proven to be poor generally.

Another problem is that although most experimental results are in the format of empirical mean-deviation pairs, an empirical mean-deviation pair can not be turned easily into an interval, unless some hypothesis about the underline distribution of the measured data be made and tested. Even the underline distribution of the measured data is known precisely, the interval has to be quite large to make sure that the probability for the true value to be outside the interval is negligible. For example, while the theoretical probability for a random value of Gaussian distribution to be outside the theoretical range of [mean−3*deviation, mean+3*deviation] is about 10⁻⁶, but if a data set is generated randomly from the Gaussian distribution, the data count has to exceed at least 10³ for the inference probability to be close to 10⁻⁶ to be outside the empirical range of [mean−3*deviation, mean+3*deviation]. In another word, the requirements on sample count and data consistency is usually too high to turn a mean-deviation pair into a sharp interval, or the interval may be too large to be meaningful. The interval arithmetic will then broaden these initial intervals needlessly more.

Because the vast broadening of equation (6) for subtraction, affine arithmetic is developed as an improvement to interval arithmetic. Affine arithmetic associates with each value an error in term of linear combination of each error source εᵢ:
δX=Σᵢ(xᵢ εᵢ) δY=Σᵢ(yᵢ εᵢ) (8)
Then, it calculates the error of addition and subtraction as:
δ(X+Y)=Σᵢ((xᵢ+yᵢ)εᵢ) (9)
δ(X−Y)=Σᵢ((xᵢ−yᵢ)εᵢ) (10)

Because of its expense in storage and execution, and dependence on approximate modeling for operations even as basic as multiplication and division, affine arithmetic has not been widely used. The following is reference list on affine arithmetic:
1 J. Stolfi, L. H. de Figueiredo, An introduction to affine arithmetic, TEMA Tend. Mat. Apl. Comput., 4, No. 3 (2003), 297-312.

Is the strictness of interval arithmetic necessary in most cases? In real world, there is almost nothing absolute, so some statistical techniques and concepts are very helpful in handling the X-δX pair. Let error ratio of a value-precision pair X-δX be the possibility of the true value X to be outside the range[X−δX, X+δX]. The error ratio of an algorithm is the increase of the error ratio between its input and output. Thus, the conventional floating point arithmetic has representation-specific and very high accuracy, but very large and algorithm-specific error ratio, so its accuracy is not all true; while the interval arithmetic has universal zero error ratio, but very small and algorithm-specific true accuracy. Most experimental input data ranges are obtained statistically as empirical mean-deviation pairs and they do not have zero error ratio, e.g., for Gaussian distribution, their error ratio is always more than 0.174, the value when the sampling count is large enough to satisfy limit theorems. So arithmetic with error-tracking capability that contributes an additional small amount to the error ratio should be justified in normal uses. Or in another word, there should be a compromise between higher accuracy and lower error ratio in floating point calculations, as the classical compromise between higher gain and lower error for an amplifier with negative feedback. Small compromise on error ratio will improve the true accuracy noticeably, or there seems to be reasonable middle grounds between conventional floating point algorithm and interval arithmetic.

The New Floating-Point Representation of this Invention

FIG. 2 is the primary figure shown this invention. This invention contains a new floating-point representation called the precise representation 101, comprising a sign portion 102, a significand portion 103, and an exponent portion 104. The exponent portion 104 contains the exponent of 2 of the floating point number. The precise representation 101 interprets the value 105 of a floating-point precise value as “sign significand×2^{exponent}”, and the precision 106 of the floating-point precise value as “2^{exponent}”. Let the content of a floating point number be denoted as “sign significand @ exponent”. The precise representation interprets 1@0 and 2@−1 differently as 1±1 and 1±0.5 respectively, instead of interpreting both of them as precise 1 as in the polymorphic representation of the conventional floating-point representation. The value of the least significant bit of the “significand” is viewed as imprecise and somewhat random.

In the precise representation, every combination of “sign significand@ exponent” represents a valid and unique value except negative zeros, which can be reinterpreted as error codes, each of which is generated due to illegal arithmetic operation, such as underflow or overflow of either significand portion or exponent portion, and dividing by zero. An operand error code is directly transferred to the operation result. In this way, illegal operations can be traced back to the source.

Each precise value can be initialized with a value and a precision, both of which could be in a conventional floating-point format. If the precision is not specified, the precise value will have the smallest possible precision for the value. An integer value is assumed to be accurate by itself. If a pair of integer values is to be used as a value-precision pair, the pair of integer values can be first converted to a pair of conventional floating-point values in conventional ways.

In reality, experimental data are usually collected with a constant precision but variable accuracy, such as the data collected by a 16-bit analog-to-digital Converter, rather than with a constant accuracy but variable precision as suggested by the conventional floating point arithmetic. The precise arithmetic thus represents the real world better.

A precise representation can have the same partition as one of the conventional floating-point representation (such as according to ANSI/IEEE Standard 754-1985) but without the normalization process of the conventional floating-point representation.

The following is a method to turn a conventional floating-point value into a precise value:
1 if the conventional floating-point value is not a numerical value, the floating-point conversion arithmetic operation results in an exceptional condition;
2 if the conventional floating-point value is zero, the precise value is the most precise zero;
3 if the significand of the conventional floating-point value is not larger than the largest possible significand of the precise value, obtain the precise value by the sequence of:
   (a) assigning the significand of the conventional floating-point value to the significand of the precise value;
   (b) assigning the exponent of the conventional floating-point value to an integer;
   (c) when the most significant bit of the significand of the precise value is zero, left shifting the significand of the precise value while decrementing the integer for each left shift of the significand of the precise value;
   (d) assigning the integer to the exponent of the precise value; and
   (e) assigning the sign of the conventional floating-point value to the sign of the precise value;
4 if the significand of the conventional floating-point value is larger than the largest possible significand of the precise value, obtain the precise value by the sequence of:
   (a) assigning the exponent of the conventional floating-point value to the exponent of the precise value;
   (b) assigning the significand of the conventional floating-point value to a unsigned integer;
   (c) when the unsigned integer is larger than the largest possible significand of the precise, right shifting unsigned integer while incrementing the exponent of the precise value for each right shift of the unsigned integer;
   (d) assigning the unsigned integer value to the significand of the precise value; and
   (e) assigning the sign of the conventional floating-point value to the sign of precise value.

Similarly, the reverse process can be use to obtain the conventional floating-point values of either “Sign Significand @ Exponent” or “1 @ Exponent”, which represent the value and the precision of a precise value respectively.

The following is a method to turn a integer value into a precise value:
1 if the integer value is zero, the precise value is the most precise zero;
2 if the magnitude of the integer is not larger than the largest possible significand of the precise value, obtain the precise value by the sequence of:
   (a) assigning zero to the exponent of the precise value;
   (b) assigning the magnitude of the integer value to the significand of the precise value;
   (c) when the most significant bit of the significand of the precise value is zero and the exponent of the precise value is larger than the smallest possible value of the exponent, left shifting the significand of the precise value while decrementing the exponent of the precise value for each left shift of the significand of the precise value; and
   (d) assigning the sign of the integer value to the sign of precise value;
3 if the magnitude of the integer is larger than the largest possible significand of the precise value, obtain the precise value by the sequence of:
   (a) assigning zero to the exponent of the precise value;
   (b) assigning the magnitude of the integer value to a unsigned integer;
   (c) when the unsigned integer is larger than the largest possible value of the significand of the precise value, right shifting the unsigned integer while incrementing the exponent of the precise value for each right shift of the unsigned integer;
   (d) assigning the unsigned integer to the significand of the precise value; and
   (e) assigning the sign of the integer value to the sign of precise value.

A reduction operation is required to turn a value-precision pair both in conventional floating-point representations into a precise value. A precise value after reduction has the closest value to the precise value before reduction, but the precise value after reduction has significand of either 0 or 1. The following is a method to reduce a precise value:
1 if the significand of the precise value before reduction is either 0 or 1, the precise value is the required result;
2 if the significand of the precise value before reduction is larger than 1, obtain the precise value after reduction by the sequence of:
   (a) when the significand of the precise value being larger than 3, right shifting the significand of the precise value while incrementing the exponent of the precise value for each right shift of the significand of the precise value;
   (b) incrementing the exponent of the precise value once if the significand of the precise value is 2, or incrementing the exponent of the precise value twice if the significand of the precise value is 3; and
   (c) right shifting the significand of the precise value.

The following is a method to turn a value-precision pair both in conventional floating-point representations into a precise value:
1 if the conventional floating-point precision is zero, convert the conventional floating-point value to the precise value;
2 if the conventional floating-point precision is not zero, obtain the precise value by the sequence of:
   (a) converting the conventional floating-point precision to the precise value;
   (b) reducing the precise value;
   (c) assigning the exponent of the precise value to an integer;
   (d) converting the conventional floating-point value to the precise value; and
   (e) rounding-off the precise value to the integer.

One embodiment of the present invention is to implement a 64-bit precise floating-point representation as a CPrecise type in C++. The CPrecise uses the 64-bit ANSI/IEEE Standard 754-1985 floating-point partition, but without normalization and the hidden most significant bit for the significand. Due to this hidden bit, the maximal accuracy of a CPrecise value is one bit less than the 64-bit ANSI/IEEE Standard 754-1985 floating-point value. When a CPrecise variable is initialized with a value without precision, such as an integer, the precision is twice of that of the 64-bit ANSI/IEEE Standard 754-1985 floating-point variable of the same value, such as the DBL_EPSILON for the double type with value of 1.
1=2⁵¹@−51=1±2⁻⁵¹ DBL_EPSILON=2⁻⁵²
Similar to a conventional floating-point representation, the bit limitation of significand of a CPrecise variable brings a limit to accuracy and precision, so that when a value doubles, the precision of most precise representation also doubles:
2=2⁵¹@−50=2±2⁻⁵⁰
Different from a conventional floating-point representation, a CPrecise value can be initialized with a value and a precision, such as:
1.000±0.001=1024@−10=1±2⁻¹⁰
In this embodiment of precise representation, the precision is round up to the closest precision in the representation. In the above example, 1024@−10 is used instead of 512@−9, and the true precision is slightly smaller than the input precision. In other embodiment of precise representation, the precision is round up to the closest larger precision in the representation so that the resultant range is guaranteed to cover the original range.
The New Floating-Point Arithmetic of This Invention

This invention also contains a new floating-point arithmetic on the precise representation called the precise arithmetic, which tries to limit the calculation error at the least significant bit of the significand of each precise value.

The precise arithmetic assumes that the distinct operands of any arithmetic operation are not correlated at all. For example, it uses equation (1) in determining the result precision for addition and subtraction when the two operands are not identical. It represents a statistical underestimation of addition error, and a statistical overestimation of the subtraction error. Because subtraction is much more effective in wronging accuracy than addition, this approach is justified. The following is a summary of equations for calculating result precisions of arithmetic operations, in which X and Y are two distinct operands:
δ(X+X)=δX 2 (11)
δ(X+Y)=√((δX)²+(δY)²) (12)
δ(X−X)=0 (13)
δ(X−Y)=√((δX)²+(δY)²) (14)
δ(X²)=δX 2 X (15)
δ(X Y)=√((δX)² Y²+(δY)² X²) (16)
δ(X/X)=0 (17)
δ(X/Y)=√((δX)²/Y²+(δY)² X²/Y⁴) (18)
δ(√X)=δX/2/√X (19)

The following is an general operations rules that allows construction of result precision for any arithmetic operations, in which X, Y, and Z are three operands:
δ(X+Y)=δ(Y+X) (21)
δ(X+Y+Z)=δ((X+Y)+Z)=δ(X+(Y+Z)) (22)
δ(X Y)=δ(Y X) (23)
δ(X Y Z)=δ((X Y)Z)=δ(X(Y Z)) (24)
δ(f(X))=|f′(x)|δX (25)

Instead of using the above equations directly in some embodiments of the precise arithmetic, the result of equation (12) can be multiplied by a precision factor of addition, which is slightly larger than 1, to take account of the under-estimation of addition precision by equation (12). The same precision factor may be applied to equation (16) since multiplication is a repeated addition. A larger precision factor means more reliability but less accuracy for addition and multiplication operations, in the same way as a larger feedback parameter of a classical negative feedback amplifier means higher signal quality after amplification but lower signal amplification. Similarly, an amplifying factor of subtraction may be applied to equation (14) and (17). An alternative embodiment is to use (6) instead of (12), and similar equation to replace (16). Different application may require different precision factors.

After a result precision in a conventional floating-point format is calculated, it needs to be turned into the the exponent of the result precise value in two steps A reduction operation is required to turn a result precision into the exponent of the result precise value.

Direct implementation of the above equations and the precision factors may require extensive use of floating-point arithmetic unit. However, some embodiment of the precise arithmetic may take into consideration the precise representation itself and use the following scheme to reduce the requirements on hardware and the amount of calculation greatly. From the above equations, a precise arithmetic operation on two distinct operands generates two intermediate precisions for the result. These two precisions are reduced as two precise values each of which are with significand less than 2 and each of which has value closest to the corresponding precision. If the two result exponents of the two precise values are different, the algorithm result is round off to the larger exponent using a precision round-off rule. If they are equal, a precision fine tune rule is applied to possibly increment the result exponent by 1 and correspondingly right shift the significand of the result precise value. A more aggressive precision fine tune rule increases the range specified by [value−precision, value+precision] faster, thus favors more reliability than accuracy of results. Different application or different algorithm may each have difference best choice of precision fine tune rules. In this patent application, a string policy marker of three characters is used to identify the precision tracking policies in this patent application, whose first character identifies the precision round-off rule, and second and third characters identify the precision fine tune.

When a precision value needs to be rounded off to a larger exponent, the immediate bit below the targeted least significant bit of significand is called the half bit. If it is 0, it is simply discarded during round-off, such as rounding off 896@−7 to 448@−6. If it is 1, except always rounding off “1@ exponent” to “0@ (exponent+1)”, there are actually three different ways to round it off, as indicated by the first character of the policy marker:
“C”: Always carry it over, so that 897@−7 (7.008±0.008) becomes 449@−6 (7.016±0.016).
“T”: Always discard it, so that 897@−7 (7.008±0.008) becomes 448@−6 (7.000±0.016).
“X”: Randomly carry it over or discard it with a 1/2 probability of each choice.
   The choices of precision round off rule are analog to the common different ways to cast a floating point value to an integer value, or to normalize a result of addition or multiplication in conventional floating point arithmetic. Different applications or different algorithms may each have difference best choice of precision round-off rules, although most applications and most algorithms may favor the “C” policy.

When two values of different exponents are added or subtracted, the operand with smaller exponent is first rounded off to the larger exponent before the two significands are added or subtracted. So the result of adding zero to or subtracting zero from a precise value may be different from the original value:
898@−7±0@−6=449@−6 7.016±0.008±0±0.016=7.016±0.016

When two distinctive operands of same exponents are added or subtracted, there are choices of precision fine tune rules, as indicated by the second and third characters of the policy marker:
“NV”: Never. The result of “NV” precision fine tune rule mimics the result of using conventional floating-point arithmetic.
“10”: Whenever the least significant bits of the two operands generates a carry for the operation, as shown in the following examples of subtraction:
   898@−7−897@−7=0@−6 7.016±0.008−7.008±0.008=0.000±0.016
   899@−7−897@−7=2@−7 7.023±0.008−7.008±0.008=0.016±0.008
“11”: Whenever the two least significant bits are both 1, as shown in the following examples of subtraction:
   898@−7−897@−7=1@−7 7.016±0.008−7.008±0.008=0.008±0.008
   899@−7−897@−7=1@−6 7.023±0.008−7.008±0.008=0.016±0.016
“01”: Whenever the least significant bit of the second operand is 1. “10” precision fine tune rule is conceptually better, while the results of “11” precision fine tune rule look better. Because these two precision fine tune rules increase precision less than what the statistics calls for, 5/4 fold vs. √2 fold on average, “01” precision fine tune rule increases the result precision to 3/2 fold on average by combining “10” and “11” precision fine tune rules.
“M1: Whenever the least significant bit of the second operand is 1 for subtraction, and whenever the least significant bit of the greater-or-equal significand of the two operands is 1 for addition. Because “01” precision fine tune rule breaks the symmetry for addition, “M1” precision fine tune rule restores the symmetry for addition while being equivalent to the “01” precision fine tune rule. In most cases, “M1” precision fine tune rule gives the most balanced results on both reliability and accuracy.
“L1”: Whenever the least significant bit of the second operand is 1 for subtraction, and whenever the least significant bit of the smaller-or-equal significand of the two operands is 1 for addition. “L1” precision fine tune rule is assumed to be equivalent to “M1” precision fine tune rule but it actually has worse result than “M1” precision fine tune rule in a few algorithms which has been tested. So “L1” precision fine tune rule is provided here for completeness of enumeration.
“00”: Whenever the least significant bit of any of the two significand is 1 for addition, or whenever the least significant bit of the first significand is 0 for subtraction, or whenever the least significant bit of the second significand is 1 for subtraction. “00” precision fine tune rule takes into account that the least significant bit of a significand is somewhat random, so its result is very reliable, with error ratios very close to zero, although its result precision range is often still order-of-magnitudes smaller than the result by interval arithmetic in linear applications.
“AL”: Always. The result of “AL” precision fine tune rule approaches the result of using interval arithmetic.

One interesting property of addition and subtraction in precise arithmetic is that the result accuracy of adding two similar values has more than 1/2 probability to increase by 1 bit, while the result accuracy of subtracting such two values always decreases. This property agrees with both significant arithmetic and statistics. In fact, it is well known that in an algorithm design using conventional floating arithmetic, addition of values of same precision should be promoted, while subtraction of values of similar magnitudes should be avoided. The precise arithmetic just takes care of precision during calculation directly, automatically and universally. Generally, using precise arithmetic, the error accumulation during calculation gradually makes significands smaller, thus reduces the accuracy.

When two operands “s1 S1 @ E1” and “s2 S2 @ E2” are multiplied to produce “s3 S3 @ E3”, the result exponent of multiplication “E3” is first calculated according to equation (31), which is then used to guide the multiplication process of the two operands according to equation (32).
1 @ E3←(reduce)←max(S1, S2) @ (E1+E2) (31)
S3 @ (E3−E1−E2)=S1×S2 (32)
For an example, to calculate 0@−6*897@−7, the result exponent is calculated as 897@−13, and reduced as 1@−3; then the product 0@−13 is round off as 0@−3, and the result is shown in the following:
0@−6*897@−7=0@−3 0+/−0.016*7.008+/−0.008=0+/−0.13

Because the exponent precision can be calculated first, the operand significand bits that will not contribute to the result significand can be ignored during the calculation. Thus, repeated addition can be more efficient than multiplication when combining two operand significands for multiplication.

The following is steps for implementing multiplication of a first precise value and a second precise value to produce a third precise value using significand multiplication:
1 the exponent of the third precise value is obtained by:
   (a) assigning to the exponent of the third precise value with the result of adding the exponent of the first precise value and the exponent of the second precise value, assigning to the significand of the third precise value with the larger-or-equal significand between the first precise value and the second precise value;
   (b) reducing the third precise value; and
   (c) if the precision fine-tune rule of addition is true, or if the first precise value and the second precise value have the same identity, incrementing the exponent of the third precise value;
2 the significand of the third precise value is obtained by:
   (a) assigning the exponent of the third precise value to an integer value;
   (b) assigning to the exponent of the third precise value the result of adding the exponent of the first precise value and the exponent of the second precise value; assigning to the significand of the third precise value the result of multiplying the significand of the first precise value and the significand of the second precise value;
   (c) rounding-off the third precise value to the integer value;
3 the sign of the third precise value is obtained by:
   (a) if the sign of the first precise value is different from the sign of the second precise value, and if the significand of the third precise value is not zero, assigning negative to the sign of the third precise value;
   (b) if the sign of the first precise value is same as the sign of the second precise value, or if the significand of the third precise value is zero, assigning positive to the sign of the third precise value.

The following is steps for implementing multiplication of a first precise value and a second precise value to produce a third precise value using repeated addition:
1 the exponent of the third precise value is obtained by:
   (a) assigning to the exponent of the third precise value with the result of adding the exponent of the first precise value and the exponent of the second precise value, assigning to the significand of the third precise value with the larger-or-equal significand between the first precise value and the second precise value;
   (b) reducing the third precise value; and
   (c) if the precision fine-tune rule of addition is true, or if the first precise value and the second precise value have the same identity, incrementing the exponent of the third precise value;
2 the significand of the third precise value is obtained by:
   (a) assigning to an integer E with the result of the exponent of the third precise value minus exponent of the first precise value minus exponent of the second precise value; assigning to an integer SL with the larger-or-equal significand between the first precise value and the second precise value; assigning to an integer SS with the smaller-or-equal significand between the first precise value and the second precise value; assigning zero to the significand of the third precise value;
   (b) when SS is not zero, decrementing E and right shifting SS, and for each repeat, if the least significant bit of SS is not zero, adding to the significand of the third precise value the result of right shifting SL by E bits;
3 the sign of the third precise value is obtained by:
   (a) if the sign of the first precise value is different from the sign of the second precise value, and if the significand of the third precise value is not zero, assigning negative to the sign of the third precise value;
   (b) if the sign of the first precise value is same as the sign of the second precise value, or if the significand of the third precise value is zero, assigning positive to the sign of the third precise value.

Similar technique can be applied to division, to obtaining the result by first calculating the result exponent according to equation (33) and then achieving division by a series of subtraction and shift on contributing significand bits of the two operands only, according to equation (34).
1@ E3←(reduce)←max(1/S1, S1/S2²) @ (E1−E2) (33)
S3=S1 @ (E1−E2−E3)/S2 (34)

The following is steps for implementing division of a first precise value and a second precise value to produce a third precise value:
1 if the first precise value and the second the precise value have the same identity, the third precise value is the most precise one;
2 the exponent of the third precise value is obtained by the sequence of:
   (a) assigning to the exponent of the third precise value the result of subtracting the exponent of the second precise value from the exponent of the first precise value;
   (b) (a) if the significand of the first precise value is not larger than the significand of the second precise value: (i) assigning one to the significand of the third precise value, and (ii) while the significand of the third precise value is not larger than the significand of the second precise value, left shifting the significand of the third precise value and decrementing the exponent of the third precise value for each left shift of the significand of the third precise value; or (b) otherwise: (i) assigning the significand of the first precise value to the significand of the third precise value; and (ii) while the significand of the third precise value is not larger than the square of the significand of the second precise value, left shifting the significand of the third precise value and decrementing the exponent of the third precise value for each left shift of the significand of the third precise value; and
   (c) if the precision fine-tune rule of subtraction is true, incrementing the exponent of the third precise value;
3 the significand of the third precise value is obtained by the sequence of:
   (a) assigning to an integer S with the result of left shifting the significand of the first precise value by a bit count of the exponent of the first precise value minus the exponent of the second precise value minus the exponent of the third precise value;
   (b) assigning to the significand of the third precise value with the quotient of dividing the S by the significand of the second precise value;
   (c) incrementing the significand of the third precise value if the reminder of dividing the S by the significand of the second precise value is not less than half of the significand of the second precise value;
4 the sign of the third precise value is obtained by:
   (a) if the sign of the first precise value is different from the sign of the second precise value, and if the significand of the third precise value is not zero, assigning negative to the sign of the third precise value;
   (b) if the sign of the first precise value is same as the sign of the second precise value, or if the significand of the third precise value is zero, assigning positive to the sign of the third precise value.

Without the need for conventional floating-point normalization, conventional floating-point multiplication, and conventional floating-point division, a precise arithmetic unit can be much simpler than a corresponding conventional floating-point arithmetic unit. It is conceivable that a precise floating unit is implemented using much simpler technologies than those technologies normally required by conventional floating-point arithmetic unit. Such simpler technologies include implementing the precise arithmetic unit as a library component, programmed into a reconfigurable structure, etc.

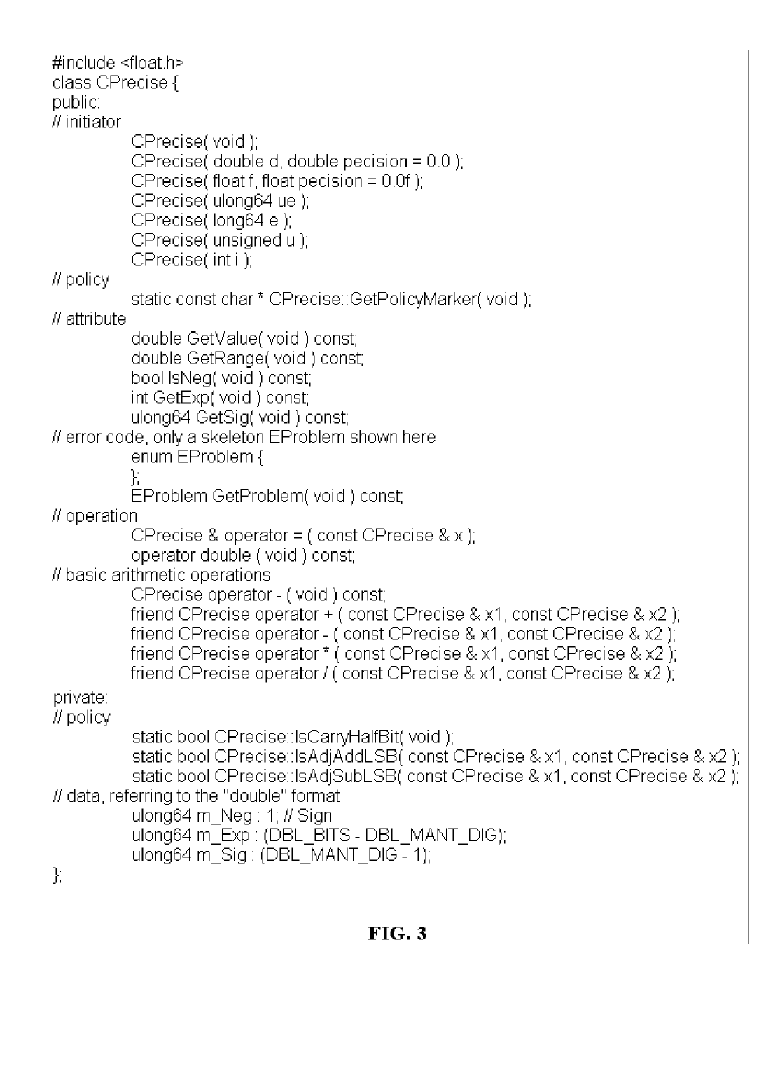

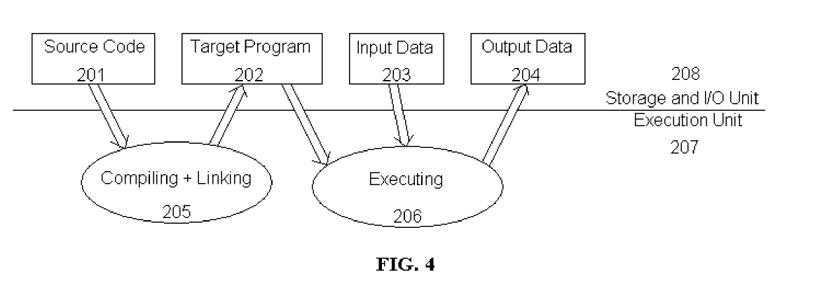

In the CPrecise embodiment of precise arithmetic, two operands of an arithmetic operation are considered distinct when these two operands do not have the same address. FIG. 3 shows a simplified interface of the CPrecise type. This embodiment of precise representation and arithmetic is done in a computer system comprising an execution unit 207 and a storage and I/O unit 208. The source code 201 containing CPrecise class is compiled and linked 205 into target program 202. The target program is executed 206 in combination with input data 203, to generate output data 204. The execution unit 207 can be a central processing unit of a computer, or a precise arithmetic unit, or other hardware such as a reconfigurable system programmed to perform precise arithmetic, or any combination of the above hardware. The storage and I/O unit 208 may comprise hard disk, memory, keyboard, pointing device, communication ports, and all hardware that is capable of interacting with exchanging data with the execution unit, directly or indirectly. In addition to normal data on any medium, the input data 203 and the output data 204 also comprise specified or designed state changes of the computer, such as performing a desired action by the computer when the input data confirms to certain specified conditions.

When (64919121×205117922−159018721×83739041) is calculated using CPrecise type of “CM1” or “C01” policy, the result is 0±4. If the significand of CPrecise type also had 54-bits as the conventional floating point representation and the interval representation, the result would be 2±2. As a comparison, the correct answer is 1, the result of conventional floating-point arithmetic is 2.0000000000000000, and the result of interval arithmetic is 2±17.74. In this case, the precise arithmetic is superior to both the conventional floating point arithmetic and the interval arithmetic by providing a correct and tightest precision range allowed by the representation significance.

The Validation of Precise Value of this Invention

This invention also contains methods for validate the precision range defined by a precise value. Each precise value has a corresponding error ratio, which is the probability of the true value to be outside the precision range of a precise value. The initial error ratio may be obtained as a result of statistical inference. The error ratio of a reading from an ideal 16-bit analog-to-digital converter can be regarded as zero. How to obtain the initial error ratio for a precise value is not the concern of the precise arithmetic. On the other hand, precise arithmetic provides a method of measuring contribution to error ratio by a precise implementation of algorithm if the algorithm has a few known accurate outputs for specific inputs. The accurate inputs of specific values are input into such an implementation of algorithm, and the precise outputs from the algorithm implementation are compared with the expected accurate outputs. The expected accurate outputs have been rounded off to the exponent of corresponding precise outputs, and each absolute difference between the significand of expected accurate output and the corresponding significand of precise output contributes to the empirical error distribution in significand. The error ratio is obtained by counting the population of the significand difference larger than 1.

In this patent application, only the error ratio of FFT will be presented, although the error ratio for other algorithms can be obtained similarly. FFT is the most popular implementation of discrete Fourier transformation to a series of 2^{L} data, in which L is a positive integer called the FFT order in this patent application. For a waveform of h[k]=sin(2 π F/2^{L} k), in which F is another positive integer less than 2^{L-1}, and k is the time index running from 0 to 2^{L}−1, the discrete Fourier transformation is H[n]=i δ_{n, F} 2^{L-1}, in which n is the frequency index running from 0 to 2^{L-1}. Similarly, for a waveform of h[k]=cos(2 π F/2^{L} k), the discrete Fourier transformation is H[n]=δ_{n, F} 2^{L-1}. The total operation count for each H[n] is exactly the FFT order L, and more error can be accumulated by increasing the order L. The result of a FFT calculation contains 2^{L} real values and 2^{L} imaginary values, which enables reliable statistical analysis. Discrete Fourier transformation is invertible, and the inverse Fourier transformation differs from the forward Fourier transformation only by the sign of a constant. For any of the above waveforms, forward Fourier transformation condenses the waveform to a single frequency component by mutual cancellation, thus more sensitive to calculation error. Inverse Fourier transformation spreads a single frequency component to whole waveform, thus less sensitive to calculation error. The subsequentially forward and inverse transformed signal can be compared with the original signal for overall calculation error. These three algorithms are identified as “FFT”, “Inv” and “Rev” respectively.

First, different precision fine tune rules are compared.

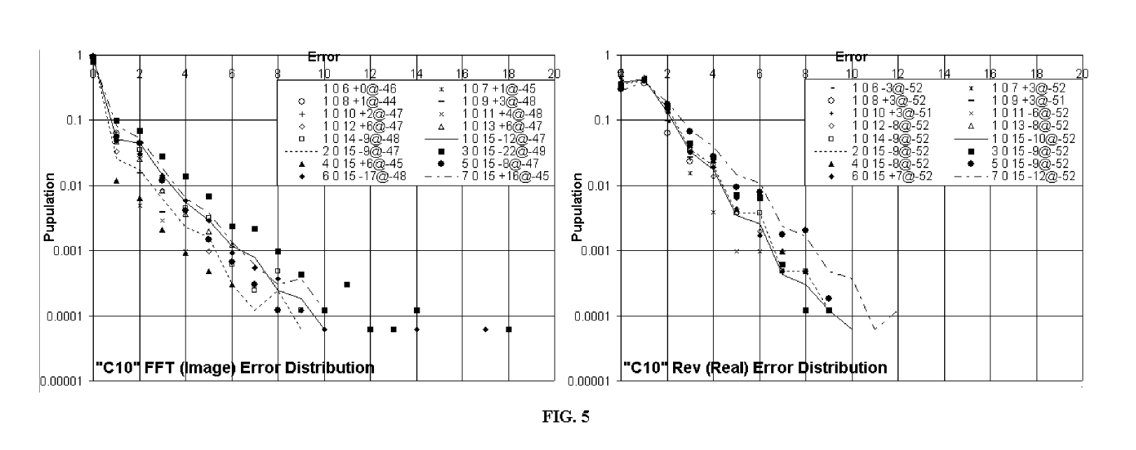

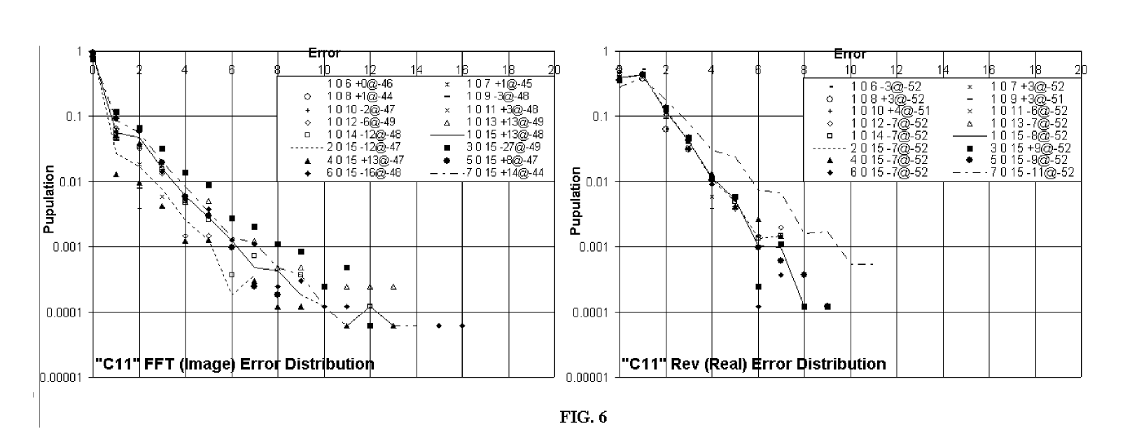

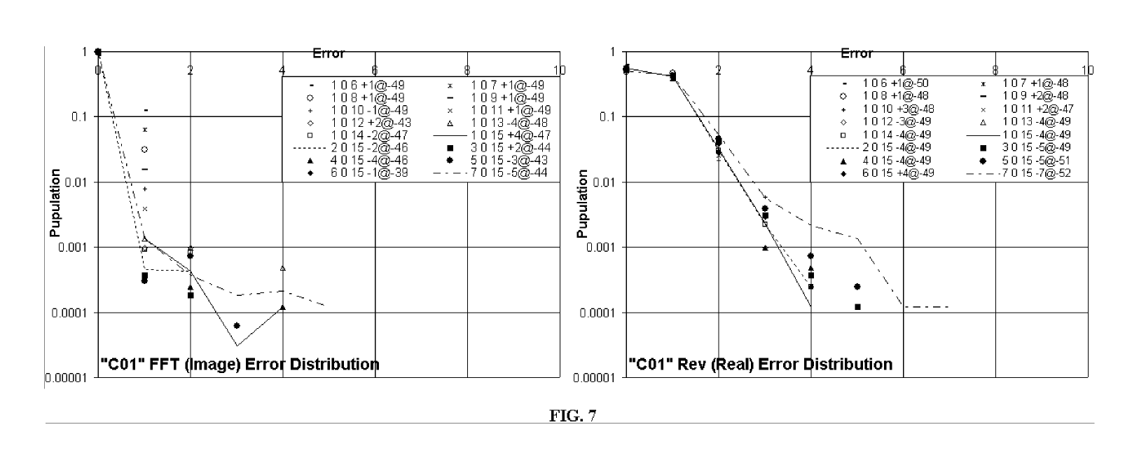

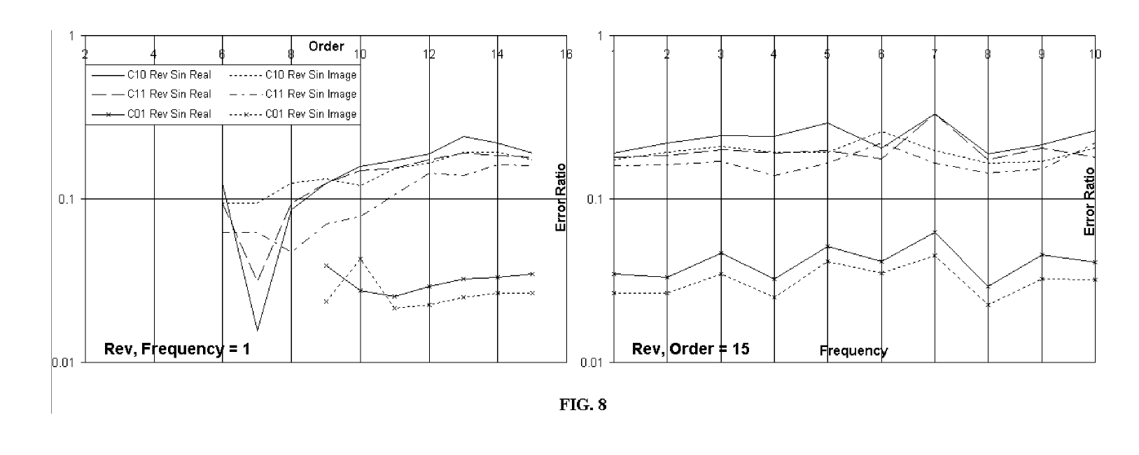

Using precise arithmetic, the extent of error propagation in significand depends on its policy. FIG. 5, FIG. 6 and FIG. 7 show the significand error distributions for “FFT” and “Rev” algorithms using either “C10” or “C11” or “C01” policies with smallest possible input precisions. The results of “Inv” algorithm are very similar to those of “Rev” algorithm except with slightly less error propagation. In each figure, the x-axis shows the significand error, the y-axis shows the error population normalized to the transform size 2^{L}, while the label shows the sine frequency, the input precision, the order of FFT calculation, and the maximal calculation error. All the results of “C10” policy are very similar to those of “C11” policy, and these two policies are statistically indistinguishable. The precise arithmetic tracks the calculation errors by increasing precision, and only allows the errors to be beyond the least significant bit of significand by few counts. With the increased FFT order, the calculation error distributions stabilize along a same histogram profile, suggesting statistical nature of the error propagation during error tracking by the precise arithmetic. In any algorithm using any policy, the stable distribution of the calculation errors beyond the least significant bit of significand follows a straight line when the population is drawing in logarithm scale, suggesting exponential distribution, which is expected from incremental propagation nature of calculation errors. The “C01” policy is more aggressive than either “C10” or “C11” policies in error tracking, so it allows less error propagation in significand.

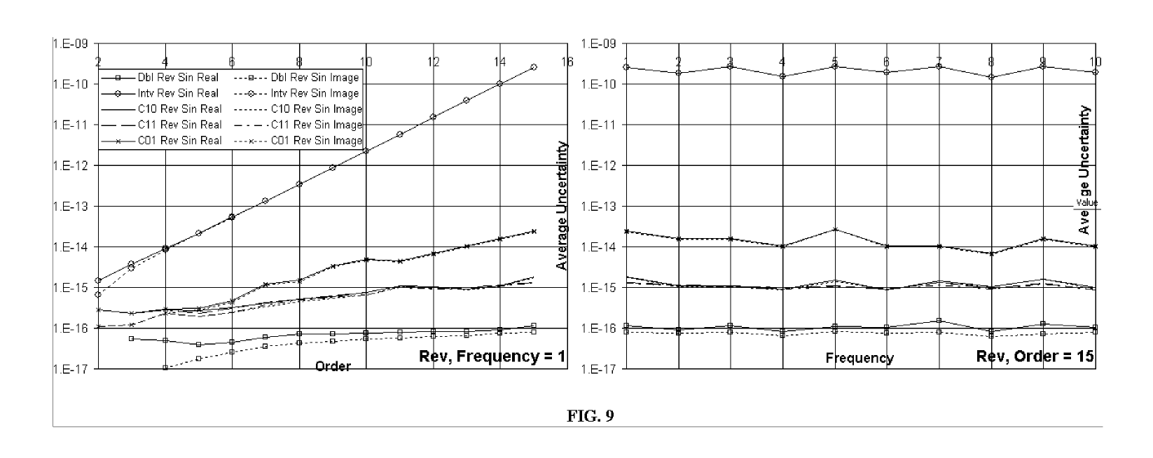

The difference between accurate and numerical results of precision calculation is described as uncertainty, which is mostly due to the output exponents, rather than the errors in output significand. When the precision fine tune rule tracks error propagation in significand more aggressively, it raises the precisions more frequently, so that the output exponents increase more quickly while error ratio is kept lower. FIG. 8 and FIG. 9 shows such relation between error ratio and output uncertainty of different precision policies. Their left charts show that with increased FFT order, both error ratios and average output uncertainties increase until stabilized, while their right charts show the variation of these two values for the same amount of calculations due to difference in input data. In FIG. 9, the output precisions provided by interval arithmetic are several order-of-magnitudes larger than those by precise arithmetic, and they increases exponentially with the FFT order, rather than linearly for this linear algorithm. Although the errors of conventional floating point arithmetic are smaller than the uncertainties of precise arithmetic, they are always clueless true errors, and their distributions are very specific to algorithm.

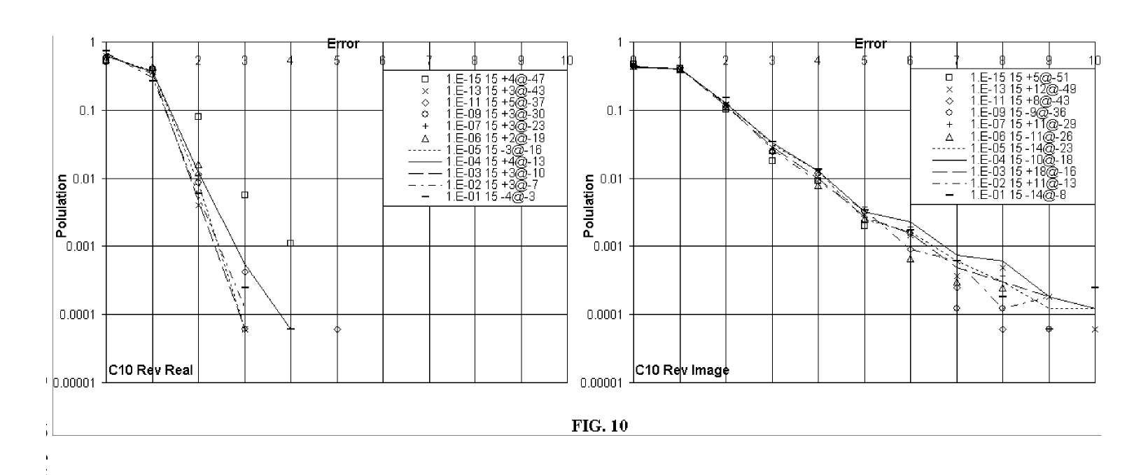

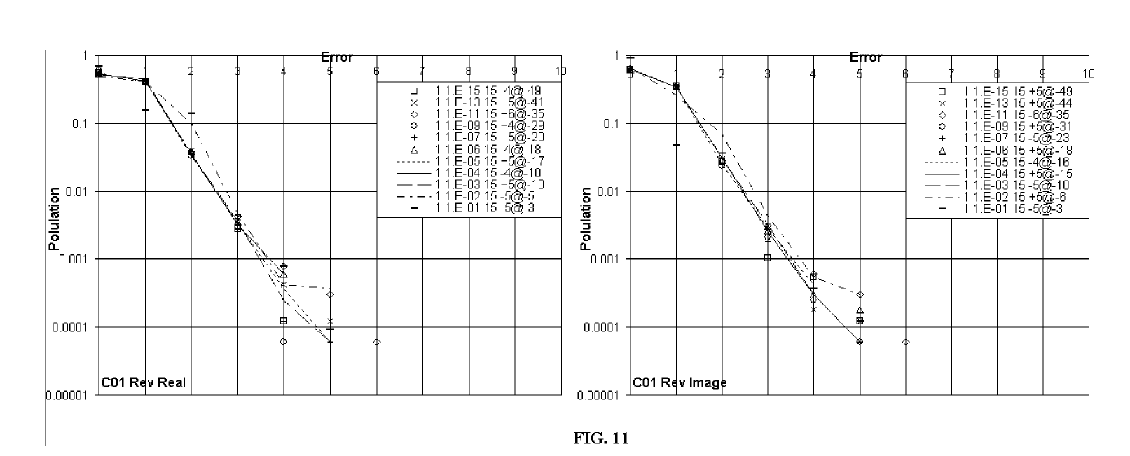

The above properties of error tracking by the precision policies are not limited to input data of smallest precision. FIG. 10 and FIG. 11 show that the error distributions of “Rev” calculation of different input precisions using either “C10” or “C01” policies are all along a same exponential distribution for each policy.

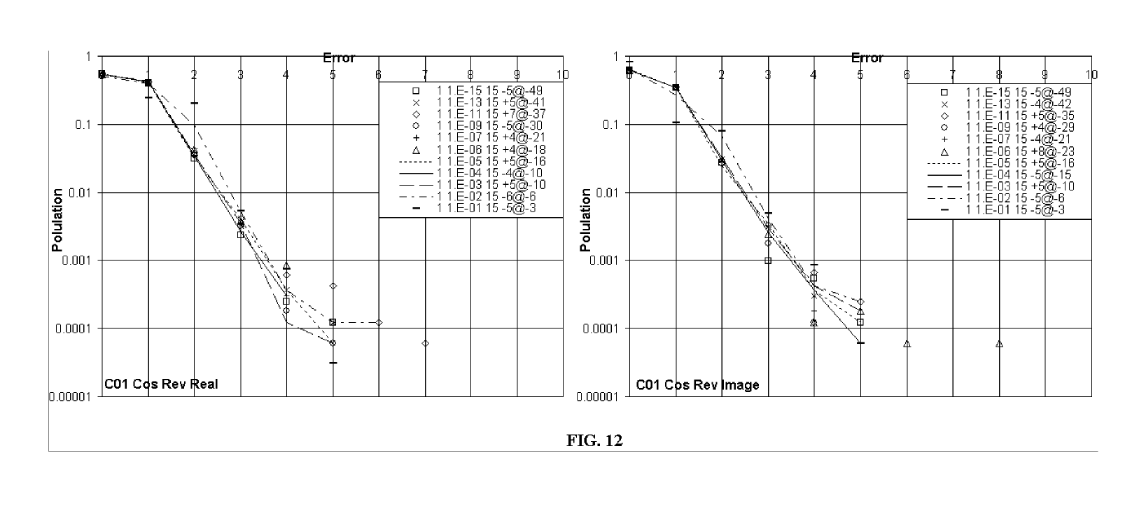

Because all three algorithms do not distinguish real and imaginary parts of input data in their algorithm execution, a good error tracking policy should track the error propagation in these two parts with similar effects, regardless of the input data. This is the case for “C01”, policy, as shown in FIG. 11, but not the case for “C10” policy, as shown in FIG. 10. In this respect, “C01”, is the better policy. The discrete Fourier spectrum of a perfect sine signal of an index frequency F is (δ_{n, F} 2^{L-1} i), while it is (δ_{n, F} 2^{L-1}) for a perfect cosine signal. Thus, the major dataflow of a perfect sine signal during the execution of either “FFT” or “Inv” algorithm is crossover between real and imaginary parts, which is just opposite from that of a perfect cosine signal. Still, using “C01” policy, the error distributions of either algorithm are statistically identical for either real or imaginary data, as shown by the strong similarity between FIG. 11 and FIG. 12. This is another numerical proof of data independence of “C01” policy in tracking errors. If this independence is generally true, the error characteristics of an algorithm using “C01” policy can be found by a simple case of known result, and then applied to all other cases for the algorithm.

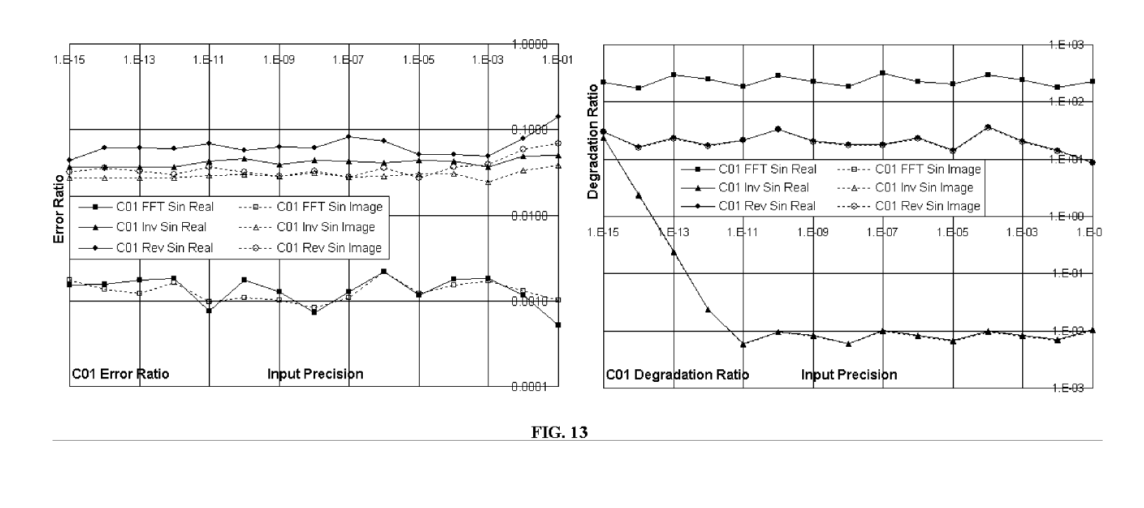

Once a precise arithmetic policy for an implementation of an algorithm is selected, the policy of the algorithm is characterized by error ratio and degradation ratio. The ratio of average output precisions to average input precisions is defined as degradation ratio of an algorithm. In addition to the stability of error distribution, both error ratio and degradation ratio are stable for each algorithm using “C01” policy regardless of input precisions, as shown in FIG. 13. The abnormal increase of degradation ratio below 10⁻¹¹ input precision for the “Inv” algorithm in FIG. 13 is probably due to the bit limit on significand when the single frequency-component is spread to construct the entire sine signal. Such increase also happens to the “Inv” algorithm using interval arithmetic due to the bit limit on significand of 64-bit IEEE floating point type.

Both error ratio and degradation ratio has simple and clear meaning. Suppose data is processed by a series of different algorithms, each of which has known error ratio e[i] and degradation ratio d[i]. Conceptually, the combined error ratio and degradation ratio for the series is:
e=1−Πᵢ e[i]=Σᵢ e[i] (41)
d=Πᵢ d[i] (42)

As shown by FIG. 13, error ratio seems to obey equation (41) statistically, e.g., at each input precision, the error ratio of “Rev” algorithm are slightly larger than that of “Inv” algorithm when the error ratio of “FFT” algorithm is much smaller. Although correctly lying between those of “FFT” and “Inv” algorithms, the degradation ratio of “Rev” algorithm calculated by equation (42) is about one order-of-magnitude smaller than the actual value at each input precision. This discrepancy is probably due to the averaging of precisions in defining the degradation ratio. Among input data, if those with larger precisions have larger contribution to the error accumulation, the current definition will give a smaller-than-expected theoretical value. As an algorithm-independent and easily measurable value, it is actually not important for the currently defined degradation ratio to satisfy equation (42) strictly, because it has an important role of rejecting meaningless calculation result, as described in the following.

If an algorithm has a constant error ratio and a constant degradation ratio, when the algorithm is repeated, each iteration increases the precisions by a degradation ratio fold, while retains the same error ratio. This characterization of repeating an algorithm is confirmed by FIG. 16 at input precisions smaller than 10⁻⁹. The deviations of error ratio and degradation ratio from their respective normal values at larger input precisions deserve closer look. The following table lists the input precision and output uncertainties of each repeat when its error ratio deviates from the normal values for the “Rev” algorithm:

| Repeat | Precision | Avg Uncertainty | Max Uncertainty |
|---|---|---|---|
| 0 | 10⁻² | 0.24 | 4 |
| 1 | 10⁻³ | 0.59 | 8 |
| 2 | 10⁻⁵ | 0.46 | 8 |
| 3 | 10⁻⁷ | 0.21 | 4 |
| 4 | 10⁻⁹ | 0.21 | 4 |

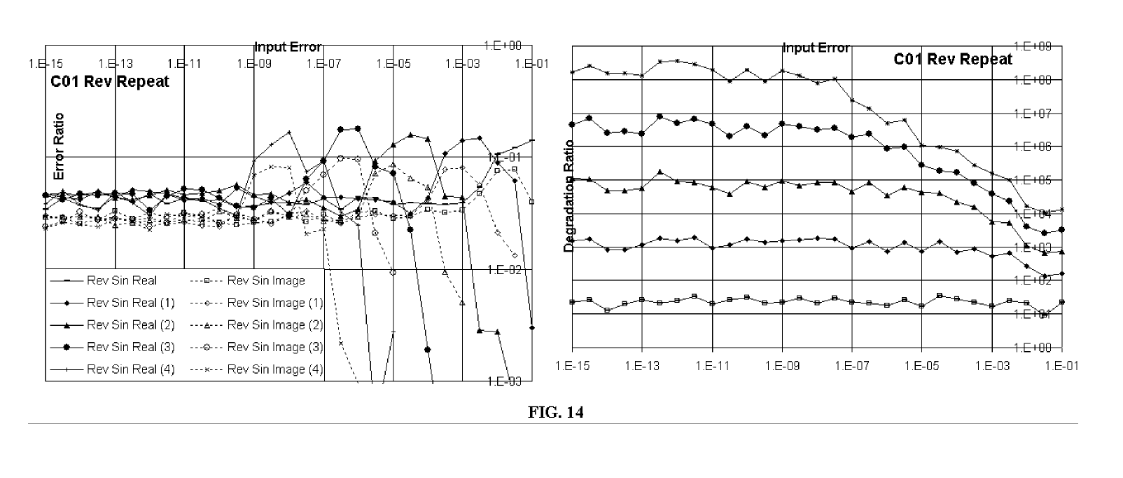

From the above table and FIG. 14, when the average output precision is comparable to the amplitude of the original sine signal, the error ratio for “Rev” algorithm starts to deviate from the normal value, and then suddenly drops to zero with larger input precision. Exactly at the same time, the degradation ratio deviates from its normal value as well. The error accumulation makes significand gradually smaller, until become frequently zero across the board, to upset the precision tracking mechanism of the precise arithmetic.

In the above scheme, the precision fine tune rule is inactivated when the significand is zero. It is possible to inactivate the precision fine tune rule for larger significand, so that of the error tracking policy breaks down for larger input precision, to guarantee better output accuracy for normal degradation ratio.

Conventionally, to reject meaningless result due to error accumulation, calculation result is evaluated by compared with the expected order-of-magnitude estimation from simplified models. However, if the algorithm is complicated, regressive, dispersive, or evolutionary over long period of time, a reliable estimation of order of magnitude is very difficult or even impossible, so that qualification of calculation results is an intrinsic problem of conventional floating point arithmetic. Because degradation ratio of an algorithm can be measured simply in real time without any knowledge of the true result, compared with the normal value of the algorithm, it can be used independently as an indicator to reject meaningless calculation result due to error accumulation using precise arithmetic.

Claim Structure

To help the patent examination process, and better understanding of the claims, the following is a map showing relations among claims, with each claim having a descriptive and informal title. However, the following map is not in any way a replacement to the claims, or a limitation on the claims.
[Claim 1] broadest method claim
   [Claim 1]->[Claim 2] a precise value using a conventional floating point format
   [Claim 1]->[Claim 3] error code method
   [Claim 1]->[Claim 4] floating-point conversion arithmetic operation
   [Claim 1]->[Claim 5] precise conversion arithmetic operation
      [Claim 5]->[Claim 6] arithmetic operation via precise conversion
   [Claim 1]->[Claim 7] round-off and reduction
      [Claim 7]->[Claim 8] best addition
         [Claim 8]->[Claim 9] minimal significand for precise fine-tune rule
         [Claim 8]->[Claim 10] best precision fine-tune rule of addition
         [Claim 8]->[Claim 11] precision fine-tune rule of addition
         [Claim 8]->[Claim 12] precision fine-tune rule of addition
         [Claim 8]->[Claim 13] precision fine-tune rule of addition
         [Claim 8]->[Claim 14] precision fine-tune rule of addition
         [Claim 8]->[Claim 15] best precision fine-tune rule of subtraction
         [Claim 8]->[Claim 16] precision fine-tune rule of subtraction
         [Claim 8]->[Claim 17] precision fine-tune rule of subtraction
         [Claim 8]->[Claim 18] subtraction
         [Claim 8]->[Claim 19] multiplication
         [Claim 8]->[Claim 20] division
   [Claim 1]->[Claim 21] error ratio
      [Claim 21]->[Claim 22] obtain error ratio for a precise value group
         [Claim 22]->[Claim 23] error ration for a process
      [Claim 21]->[Claim 24] degradation ratio
[Claim 25] broadest medium claim
[Claim 26] broadest apparatus claim

What is claimed is:

1. A computer-implemented method for representing and managing a precise value to facilitate implementing efficient storage of each value in the context of the precision of the value, and to facilitate implementing efficient arithmetic operations using the precise value, the method further comprising:
a. storing the precise value as a sign portion, a significand portion, and an exponent portion;
b. representing the value of the precise value as “sign significand×2^{exponent}”;
c. representing the precision of the precise value as “2^{exponent}”; and
d. while performing arithmetic operations involving at least one precise value, maintaining the validity of the value and precision of each precise value of the arithmetic operations.

2. An embodiment of [claim 1], wherein the precise value is stored as a conventional floating point value but without being normalized.

3. The method of [claim 1], further comprising an error code method for letting the exponent of a precise value representing a predefined symbolic value when the significand of the precise value is zero and the sign of the precise value is negative.

4. The method of [claim 1], further comprising a floating-point conversion method for converting a conventional floating-point value to a precise value, so that:
a. the value of the precise value is the closest to the conventional floating-point value; and
b. for the value of the precise value, the precision of the precise value is the smallest.

5. The method of [claim 1], further comprising a precise conversion method for converting a first conventional floating-point value and a second conventional floating-point value to a precise value, so that:
a. the precision of the precise value is the closest to the first conventional floating-point value; and
b. for the precision of the precise value, the value of the precise value is the closest to the second conventional floating-point value.

6. The method of [claim 5], further comprising an arithmetic method for calculating a result precise value of an arithmetic operation involving one precise operand or multiple precise operands, the arithmetic method further comprising:
a. calculating a result value of the arithmetic operation using each value of each precise operand;
b. method for calculating a result precision of the arithmetic operation using each value of each precise operand and each precision of each precise operand;
c. amplifying the result precision by a precision factor between 1 and 2; and
d. converting the result precision and the result value to a result precise value of the arithmetic operation using the precise conversion method.

7. The method of [claim 1], further comprising:
a. a round-off method for converting a precise value to a target exponent, so that:
i. the exponent of the precise value before round-off is not larger than the target exponent;
ii. the exponent of the precise value after round-off equals the target exponent; and
iii. for the exponent of the precise value, the value of the precise value after round-off is the closest to the value of the precise value before round-off;
b. a reduction method for reducing a precise value, so that:
i. the precise value after reduction has significand of either 0 or 1; and
ii. for the significand of the precise value, the value of the precise value after reduction is the closest to the value of the precise value before reduction.

8. The method of [claim 7], further comprising an addition arithmetic operation which adds a first precise value and a second precise value to produce a third precision value, wherein:
a. If the first precise value has the same identity as the second precise value, assign the first precise value to the third precise value and then increment the exponent of the third precise value;
b. if the sign of the first precise value is same as the sign of the second precise value, and if the exponent of the first precise value is larger than the exponent of the second precise value, obtain the third precise value by the sequence of:
i. assigning the second precise value to the third precise value;
ii. rounding-off the third precise value to the exponent of the first precise value; and
iii. adding the significand of the first precise value to the significand of the third precise value;
c. if the sign of the first precise value is same as the sign of the second precise value, and if the exponent of the first precise value is smaller than the exponent of the second precise value, obtain the third precise value by the sequence of:
i. assigning the first precise value to the third precise value;
ii. rounding-off the third precise value to the exponent of the second precise value; and
iii. adding the significand of the second precise value to the significand of the third precise value;
d. if the sign of the first precise value is same as the sign of the second precise value, and if the exponent of the first precise value equals the exponent of the second precise value, obtain the third precise value by the sequence of:
i. assigning the first precise value to the third precise value;
ii. adding the significand of the second precise value to the significand of the third precise value;
iii. if a precision fine-tune rule of addition is true for the combination of the first precise value and the second precise value, and if the significand of the third precise value is not smaller than a required minimal significand for the precision fine-tune rule, rounding-off the third precise value to one plus the exponent of the third precise value;
e. if the sign of the first precise value is not the same as the sign of the second precise value, and if the exponent of the first precise value is larger than the exponent of the second precise value, obtain the third precise value by the sequence of:
i. assigning the second precise value to the third precise value;
ii. rounding-off the third precise value to the exponent of the first precise value; and
iii. if the significand of the first precise value being not larger the significand of the third precise value, subtracting the significand of the first precise value from the significand of the third precise value; otherwise negating the sign of the third precise value and assigning to the significand of the third precise value with the result of subtracting the significand of the third precise value from the significand of the first precise value;
f. if the sign of the first precise value is not the same as the sign of the second precise value, and if the exponent of the first precise value is smaller than the exponent of the second precise value, obtain the third precise value by the sequence of:
i. assigning the first precise value to the third precise value;
ii. rounding-off the third precise value to the exponent of the second precise value; and
iii. if the significand of the second precise value being not larger the significand of the third precise value, subtracting the significand of the second precise value from the significand of the third precise value; otherwise negating the sign of the third precise value and assigning to the significand of the third precise value with the result of subtracting the significand of the third precise value from the significand of the second precise value;
g. if the sign of the first precise value is not the same as the sign of the second precise value, and if the exponent of the first precise value equals the exponent of the second precise value, obtain the third precise value by the sequence of:
i. assigning the first precise value to the third precise value;
ii. if the significand of the second precise value being not larger the significand of the third precise value, subtracting the significand of the second precise value from the significand of the third precise value; otherwise negating the sign of the third precise value and assigning to the significand of the third precise value with the result of subtracting the significand of the third precise value from the significand of the second precise value; and
iii. if a precision fine-tune rule of subtraction is true for the combination of the first precise value and the second precise value, and if the significand of the third precise value is not smaller than the required minimal significand for the precision fine-tune rule, rounding-off the third precise value to one plus the exponent of the third precise value.

9. An embodiment of [claim 8], wherein the required minimal significand for the precision fine-tune rule is one.

10. A best embodiment of the precision fine-tune rule of addition of [claim 8], wherein the least significant bit of the larger-or-equal significand between the first precise value and the second precise value is one.

11. An embodiment of the precision fine-tune rule of addition of [claim 8], wherein the least significant bit of the significand of the second precise value is one.

12. An embodiment of the precision fine-tune rule of addition of [claim 8], wherein the least significant bit of the significand of the first precise value is one.

13. An embodiment of the precision fine-tune rule of addition of [claim 8], wherein the least significant bit of the significand of the first precise value and the least significant bit of the significand of the second precise value are both one.

14. An embodiment of the precision fine-tune rule of addition of [claim 8], wherein the least significant bit of the significand of the first precise value and the least significant bit of the significand of the second precise value are either one.

15. A best embodiment of the precision fine-tune rule of subtraction of [claim 8], wherein the least significant bit of the significand of the second precise value is one.

16. An embodiment of the precision fine-tune rule of subtraction of [claim 8], wherein the least significant bit of the significand of the first precise value is zero and the least significant bit of the significand of the second precise value is one.

17. An embodiment of the precision fine-tune rule of subtraction of [claim 8], wherein either the least significant bit of the significand of the first precise value is zero or the least significant bit of the significand of the second precise value is one.

18. The method of [claim 8], further comprising a subtraction arithmetic operation which subtracts a first precise value and a second precise value to produce a third precision value, wherein:
a. if the first precise value and the second precise value have the same identity, the third precise value is the most precise zero;
b. if the first precise value and the second precise value have different identities, the third precise value is obtained by adding the first precise value and the negation of the second precise value.

19. The method of [claim 8], further comprising a multiplication method for multiplying a first precise value and a second precise value to produce a third precision value, wherein:
a. the exponent of the third precise value is obtained by:
i. assigning to the exponent of the third precise value with the result of adding the exponent of the first precise value and the exponent of the second precise value, assigning to the significand of the third precise value with the larger-or-equal significand between the first precise value and the second precise value;
ii. reducing the third precise value; and
iii. if the precision fine-tune rule of addition is true, or if the first precise value and the second precise value have the same identity, incrementing the exponent of the third precise value; and
b. for the exponent of the third precise value, the value of the third precise value is closest to the result of multiplying the value of the first precise value and the value of the second precise value.

20. The method of [claim 8], further comprising a division method for dividing a first precise value and a second precise value to produce a third precision value, wherein:
a. if the first precise value and the second the precise value have the same identity, the third precise value is the most precise one;
b. the exponent of the third precise value is obtained by the sequence of:
i. assigning to the exponent of the third precise value the result of subtracting the exponent of the second precise value from the exponent of the first precise value;
ii. (a) if the significand of the first precise value is not larger than the significand of the second precise value: (i) assigning one to the significand of the third precise value, and (ii) while the significand of the third precise value is not larger than the significand of the second precise value, left shifting the significand of the third precise value and decrementing the exponent of the third precise value for each left shift of the significand of the third precise value; or (b) otherwise: (i) assigning the significand of the first precise value to the significand of the third precise value; and (ii) while the significand of the third precise value is not larger than the square of the significand of the second precise value, left shifting the significand of the third precise value and decrementing the exponent of the third precise value for each left shift of the significand of the third precise value; and
iii. if the precision fine-tune rule of subtraction is true, incrementing the exponent of the third precise value;
c. for the exponent of the third precise value, the value of the third precise value is closest to the result of dividing the value of the first precise value and the value of the second precise value.

21. The method of [claim 1], wherein the probability of the corresponding true value to be outside the range specified by the value and the precision of a precise value is characterized by an error ratio of the precise value.

22. The method of [claim 21], wherein the error ratio of a group of precise values in which the true value of each precise value in the group is known precisely, is obtained by:
c. assigning zero to an integer error count;
d. for each precise value in the group:
i. constructing a true precise value from the true value of the precise value in the group;
ii. rounding off the true precise value to the exponent of the precise value in the group;
iii. if the absolute difference between the significand of the true precise value and the significand of the precise value in the group is larger than 1, incrementing the error count; and
e. obtaining the error ratio of the group by dividing the error count by the total count of the precise values in the group.

23. The method of [claim 22], further comprising measuring an error ratio of a process as the increase of (a) the error ratio of an output group of precise values which are output from the process from (b) an input group of error ratio of the precise values which are input into the process, each precise value in both the input group and the output group being known precisely.

24. The method of [claim 21], further comprising:
f. measuring a degradation ratio, which is the ratio of (a) the average precision of precise values which are input into a process to (b) the average precision of precise values which are output from the process;
g. measuring and storing a normal degradation ratio of the process when the output from the process agrees with the precisely expected output from the process for the input into the process; and
h. comparing the degradation ratio to the normal degradation ratio to validate the error ratio of the precise values after being manipulated by the process.

25. A computer-readable storage medium storing instructions that when executed by a computer cause the computer to perform a method for representing and managing a precise value to facilitate implementing efficient storage of each value in the context of the precision of the value, and to facilitate implementing efficient arithmetic operations using the precise value, the method further comprising:
a. storing the precise value as a sign portion, a significand portion, and an exponent portion;
b. representing the value of the precise value as “sign significand×2^{exponent}”;
c. representing the precision of the precise value as “2^{exponent}”; and
d. while performing arithmetic operations involving at least one precise value, maintaining the validity of the value and precision of each precise value of the arithmetic operations.

26. An apparatus for representing an interval within a computer system to facilitate implementing efficient storage of each value in the context of the precision of the value, and to facilitate implementing efficient arithmetic operations using the precise value, the apparatus comprising:
a. a storing mechanism that stores the precise value as a sign portion, a significand portion, and an exponent portion;
b. a value representing mechanism that represents the value of the precise value as “sign significand×2^{exponent}”;
c. a precision representing mechanism that represents the precision of the precise value as “2^{exponent}”; and
d. an arithmetic mechanism that while performing arithmetic operations involving at least one precise value, maintains the validity of the value and precision of each precise value of the arithmetic operations.
